(19) United States
(12) Patent Application Publication
(10) Pub. No.: US 2025/0201018 A1
(43) Pub. Date: Jun. 19, 2025

(54) METHOD AND DEVICE FOR ESTIMATING ATTRIBUTE OF PERSON IN IMAGE

(71) Applicant: SK TELECOM CO., LTD., Seoul (KR)

(72) Inventors: Chung Hun KANG, Seoul (KR); Jeong Yeol BAEK, Seoul (KR); Byeong Won LEE, Seoul (KR); Min Hyung CHO, Seoul (KR)

(21) Appl. No.: 18/845,597

(22) PCT Filed: Mar. 15, 2023
(86) PCT No.: PCT/KR2023/003489

§ 371 Date: Sep. 10, 2024

(30) Foreign Application Priority Data
Mar. 16, 2022 (KR) 10-2022-0032834
Mar. 17, 2022 (KR) 10-2022-0033593

(51) Int. Cl. G06V 40/16; G06V 10/75; G06V 10/82; G06V 10/98

(52) U.S. Cl. CPC G06V 40/171; G06V 10/751; G06V 10/759; G06V 10/82; G06V 10/993; G06V 40/165

(57) ABSTRACT

One aspect of the present disclosure provides a method for estimating attributes of a person in an image, the method comprising detecting an object region including a whole body region, a visible body region, and a head region of at least one person in an input image, determining whether to estimate attributes of the person based on at least one of a relative position of the head region with respect to the whole body region, or a ratio of an overlapping region between the whole body region and the visible body region, and estimating the attributes of the person based on the input image, when it is determined to estimate the attributes of the person.

### TECHNICAL FIELD

Embodiments of the present disclosure relate to a method and device for estimating the attributes of a person in an image. More specifically, embodiments of the present disclosure relate to a method and device for estimating the age or gender of a person.

### BACKGROUND

The content described hereinbelow merely provides background information on the present disclosure and does not constitute the prior art.

Recently, research is being actively conducted to measure identity, gender, number of visitors, residence time, etc. through image recognition technology, store and analyze them, and use them for marketing data, facial recognition photo albums, access control, criminal tracking, and video interpretation.

A conventional gender recognition technology captures a face image, detects a single facial region from the face image, and uses the detected single facial region to recognize the gender. However, if the image captures a wide region scene, such as a Closed-circuit Television (CCTV), it is difficult to detect a single facial region of each person in the image.

Another gender recognition technology recognizes the gender of a person from an image of the person's whole body. Specifically, the prior art extracts the body image for each person in the image, and estimates the gender of the person from the body image. The prior art may accurately estimate the gender of the person when using an image of the person looking straight ahead. However, in the image captured by a fixed camera, the person's posture may be inappropriate for estimating the gender, and occlusion may occur where a person is obscured by an obstacle.

The conventional gender recognition technology does not take various factors into account, resulting in poor accuracy in gender recognition.

### DISCLOSURE

### Technical Problems

A main object of embodiments of the present disclosure is to provide a method and device for estimating attributes of a person, which are intended to estimate the attributes only for persons who assume a posture suitable for estimating the attributes of a person among persons included in an image, thereby accurately estimating the attributes of the person.

An object of other embodiments of the present disclosure is to provide a method and device for estimating attributes of a person, which are intended to estimate the attributes only for persons in an image who are obscured to a small extent by an obstacle, thereby accurately estimating the attributes of the person.

An object of other embodiments of the present disclosure is to provide a method and device for estimating attributes of a person, which are intended to estimate the attributes only for persons whose face poses are suitable for estimating the person attributes among persons included in an image, thereby accurately estimating the attributes of the person.

An object of other embodiments of the present disclosure is to provide a method and device for estimating attributes of a person, which are intended to estimate the attributes only for persons whose facial images are less blurred, thereby accurately estimating the attributes of the person.

An object of other embodiments of the present disclosure is to provide a method and device for estimating attributes of a person, which are intended to manage tracking information of a person by using object tracking in images.

### Technical Solution

At least one aspect of the present disclosure provides a method for estimating attributes of a person in an image, the method comprising detecting an object region including a whole body region, a visible body region, and a head region of at least one person in an input image, determining whether to estimate attributes of the person based on at least one of a relative position of the head region with respect to the whole body region, or a ratio of an overlapping region between the whole body region and the visible body region, and estimating the attributes of the person based on the input image, when it is determined to estimate the attributes of the person.

Another aspect of the present disclosure provides a device for estimating attributes of a person in an image, the device comprising an object region detection unit detecting an object region including a whole body region, a visible body region, and a head region of at least one person in an input image, an estimation determination unit determining whether to estimate the attributes of the person based on at least one of a relative position of the head region with respect to the whole body region, or a ratio of an overlapping region between the whole body region and the visible body region, and an attribute estimation unit estimating the attributes of the person based on the input image, when it is determined to estimate the attributes of the person.

### Advantageous Invention

As described above, according to an embodiment of the present disclosure, it is possible to accurately estimate the attributes of a person, by estimating the attributes only for persons who assume a posture suitable for estimating the attributes of a person among persons included in an image.

According to another embodiment of the present disclosure, it is possible to accurately estimate the attributes of a person, by estimating the attributes only for persons in an image who are obscured to a small extent by an obstacle.

According to another embodiment of the present disclosure, it is possible to accurately estimate the attributes of a person, by estimating the attributes only for persons whose facial images are less blurred.

According to another embodiment of the present disclosure, it is possible to manage tracking information of a person by using object tracking in images.

### BRIEF DESCRIPTION OF THE DRAWING

FIG. 1 is a diagram showing persons photographed in various postures and situations.

FIG. 2 is a block diagram illustrating a device for estimating attributes according to an embodiment of the present disclosure.

FIG. 3 is a diagram illustrating an object region according to an embodiment of the present disclosure.

FIGS. 4A and 4B are diagrams illustrating a proper posture of a person according to an embodiment of the present disclosure.

FIGS. 5A, 5B, and 5C are diagrams illustrating various postures of a person according to an embodiment of the present disclosure.

FIGS. 6A and 6B are diagrams illustrating the occlusion degree of a person according to an embodiment of the present disclosure.

FIG. 7 is a flowchart illustrating a method for estimating attributes according to an embodiment of the present disclosure.

FIG. 8 is a diagram showing head images photographed in various situations.

FIG. 9 is a block diagram illustrating a device for estimating attributes according to an embodiment of the present disclosure.

FIGS. 10A, 10B, and 10C are diagrams illustrating the determination of the estimation suitability of a facial region according to an embodiment of the present disclosure.

FIG. 11 is a diagram illustrating the determination of the blur amount of a facial region according to an embodiment of the present disclosure.

FIG. 12 is a diagram showing facial landmarks according to an embodiment of the present disclosure.

FIG. 13 is a diagram illustrating the estimation of a face pose according to an embodiment of the present disclosure.

FIG. 14 is a flowchart illustrating a method for estimating attributes according to an embodiment of the present disclosure.

FIG. 15 is a block diagram illustrating a device for estimating attributes according to an embodiment of the present disclosure.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

The terms such as ‘unit’, ‘module’, and the like refer to one or more units for processing at least one function or operation, which may be implemented by hardware, software, or a combination thereof. Also, functions of each component may be implemented as software, and the microprocessor may be implemented to execute the functions of the software corresponding to each component.

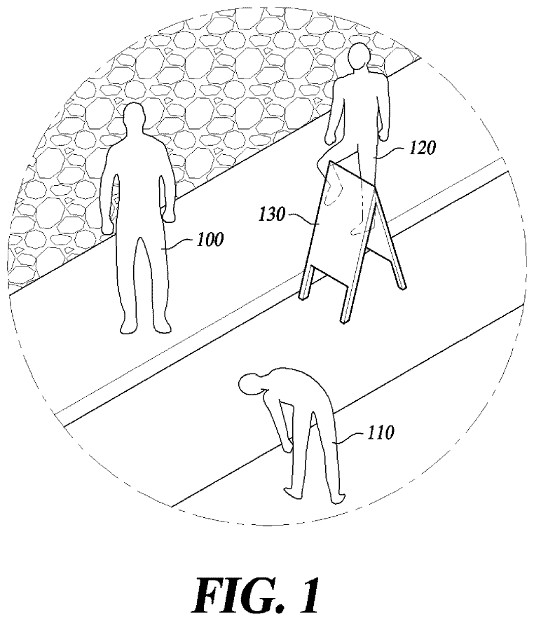

FIG. 1 is a diagram showing persons photographed in various postures and situations.

Referring to FIG. 1, a first object 100 for a person looking straight toward a camera, a second object 110 for a person with his or her upper body bent, and a third object 120 for a person whose lower body is obscured by an obstacle 130 are shown in an image.

An estimation device for estimating attributes such as the age or gender of a person in the image detects a object corresponding to the person in the image, and estimates the attributes of the person based on the detected object. At this time, if the object is not facing the camera directly or the object is obscured by the obstacle, it is difficult for the estimation device to accurately estimate the attributes of the person corresponding to the object.

In FIG. 1, since the second object 110 is not facing the camera and the third object 120 is not obscured by the obstacle 130, there is a high probability that the estimation device incorrectly determines the attributes of each of the second object 110 and the third object 120. This deteriorates recognition performance for the object attributes.

On the other hand, the estimation device may estimate the attributes of the first object 100 facing the camera more accurately than the attributes of the second object 110 and the third object 120.

As such, if the estimation device distinguishes between a person who is the target of attribute estimation and a person who is not the target of attribute estimation based on the person's posture and the degree of occlusion, providing incorrect information about the person who is not object to attribute estimation can be prevented. That is, the entire attribute recognition performance can be improved.

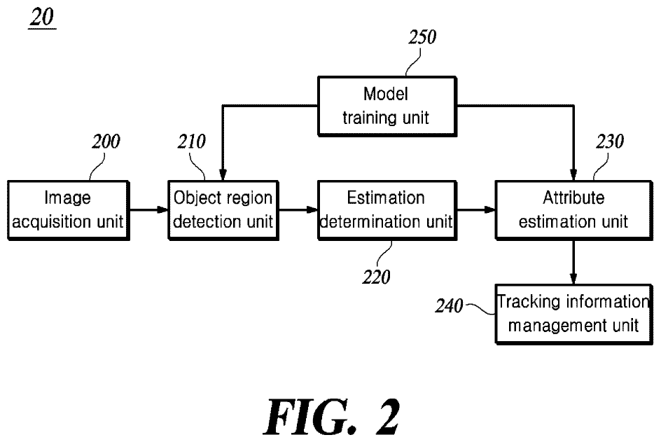

FIG. 2 is a block diagram illustrating a device for estimating attributes according to an embodiment of the present disclosure.

Referring to FIG. 2, the attribute estimation device 20 includes a object region detection unit 210, an estimation determination unit 220, and an attribute estimation unit 230. The attribute estimation device 20 may further include at least one of an image acquisition unit 200, a tracking information management unit 240, or a model training unit 250.

The image acquisition unit 200 acquires an input image by capturing a scene including a person using the camera. Here, the camera may be an AI camera that photographs the scene and processes the photographed image.

Although an operation for estimating the attributes of any selected specific person in an image will be described below, the operation may be equally applied to several persons in the image.

The object region detection unit 210 detects a region including part or all of the specific person among persons in the input image.

Specifically, the object region detection unit 210 detects an object region including a whole body region, a visible body region, and a head region of a specific person in the input image. Here, the head region is a region including the head of the specific person. The visible body region is a region including parts of a specific person's body that are not obscured by an obstacle. The whole body region is a region including the whole body of the specific person, and is a region including both a region where the specific person is obscured by the obstacle and a region where the specific person is not obscured. The regions are detected independently of each other.

According to an embodiment of the present disclosure, the object region detection unit 210 may detect the object region using a detection model based on a deep neural network.

When the input image including a person is input, the detection model provides edge coordinates of at least one of the whole body region, visible body region, or head region of a person. For example, the detection model provides the upper-left coordinate, lower-left coordinate, upper-right coordinate, and lower-right coordinate of a person's whole body region. Moreover, the detection model may provide confidence for each region. The confidence may be quantified as a value between 0 and 1. At this time, it is difficult to use a region with low confidence.

To create the detection model, the model training unit 250 trains the detection model to detect the object region in the input image when the detection model receives the input image.

The detection model may be trained using supervised learning. The model training unit 250 prepares images containing persons, and labels a region containing each person. Labeled images are input to the detection model as a training data set. Neural network parameters are updated so that the detection model detects the region containing each person. Alternatively or additionally, the model training unit 250 may train the detection model using other training methods, such as unsupervised learning or reinforcement learning.

The detection model may be composed of the deep neural network, and may have various neural network structures. For example, the detection model may have various neural network structures capable of implementing an image processing technique, such as a Recurrent Neural Network (RNN), a Convolutional Neural Network (CNN), or a coupling structure of RNN and CNN.

The object region detection unit 210 may adjust the size of the input image to use the detection model.

Meanwhile, the object region detection unit 210 may detect a torso region of a specific person. The object region detection unit 210 may use the deep neural network-based detection model to estimate the torso region.

The estimation determination unit 220 determines whether to estimate the attributes of a specific person based on at least one of the posture of the specific person or the degree of occlusion.

To determine the posture of a specific person in the input image, the estimation determination unit 220 uses the relative position of the head region with respect to the whole body region of the specific person. Specifically, the estimation determination unit 220 sets a region of interest within the whole body region. Here, the region of interest is an appropriate head position relative to the whole body region, and may be the upper region of the whole body region. The estimation determination unit 220 determines whether the posture of the specific person is appropriate, that is, whether to estimate the attributes of the specific person, based on the overlap or overlapping area between the region of interest and the head region.

As a first example, when a part of the head region is located within the region of interest, the estimation determination unit 220 may determine to estimate the attributes of the specific person. As a second example, when the entire head region is located within the region of interest, the estimation determination unit 220 may determine to estimate the attributes of the specific person. As a third example, when a part of the head region is located outside the region of interest, the estimation determination unit 220 may determine not to estimate the attributes of the specific person. As a fourth example, when the entire head region is located outside the region of interest, the estimation determination unit 220 may determine not to estimate the attributes of the specific person.

Meanwhile, in order to determine the occlusion degree of the specific person, the estimation determination unit 220 uses the ratio of a region where the whole body region overlaps the visible body region. Specifically, the estimation determination unit 220 calculates Intersection over Union (IoU) between the whole body region and the visible body region.

Here, IoU is a value obtained by dividing the overlapping area of the two regions by a total area of the two regions summed. IoU between regions A and B may be expressed as Equation 1.

$$IoU ( A , B ) = \frac{( A ⋂ B )}{( A ⋃ B )} \qquad [ Equation 1 ]$$

When the ratio of the overlapping region between the whole body region and the visible body region is higher than a preset ratio, the estimation determination unit 220 may determine to estimate the attributes of the specific person. That is, when the degree to which the specific person is obscured by the obstacle is low, the estimation determination unit 220 determines to estimate the attributes of the specific person. In contrast, when the degree to which the specific person is obscured by the obstacle is high, the estimation determination unit 220 determines not to estimate the attributes of the specific person.

When it is determined to estimate the attributes of the specific person, the attribute estimation unit 230 estimates the attributes of the specific person included in the input image.

Here, the attributes include at least one of gender or age. That is, the attribute estimation unit 230 may estimate at least one of the gender or age of the specific person. Here, the gender refers to either female or male. The age may be estimated as a specific number or as an age range such as teenagers, 20s, 30s, 40s, etc. In addition, the attributes of the specific person may include various pieces of physical information such as race, ethnicity, or emotion.

The attribute estimation unit 230 may estimate the gender or age of the specific person based on the torso region of the specific person.

According to an embodiment of the present disclosure, the attribute estimation unit 230 may estimate the attributes of the specific person using the deep neural network-based estimation model. When the image of the person's torso is input, the estimation model provides at least one of gender or age. The estimation model may further provide the confidence of at least one of gender or age. The confidence may be quantified as a value between 0 and 1.

In order to create the estimation model, the model training unit 250 trains the estimation model to output at least one of gender or age when the estimation model receives the torso image.

The estimation model may be learned by various learning methods such as supervised learning, unsupervised learning, or reinforcement learning. The estimation model may have various neural network structures such as RNN or CNN.

The estimation model estimates the attributes of a person more accurately when the person is facing straight ahead and is less obscured by the obstacle.

As described above, the attribute estimation device 20 may improve the overall estimation accuracy of the attributes of the person in the image by filtering the person whose attributes are to be estimated based on the posture and degree of occlusion of the person in the image.

Meanwhile, according to an embodiment of the present disclosure, the attribute estimation device 20 may include the tracking information management unit 240 to track the person's movement in a plurality of images and manage the tracking information.

After estimating the attributes of the specific person in the current input image, the tracking information management unit 240 checks whether the input image acquired by the image acquisition unit 200 is a first image.

If the input image is the first image, the tracking information management unit 240 generates tracking information based on the position information and estimated attributes of the whole body region of the specific person. The generated tracking information includes at least one of the identification information of the specific person, the coordinates of the whole body region, the confidence of the coordinates, the estimated age, the confidence of the estimated age, the estimated gender, or the confidence of the estimated gender.

If the input image is not the first image, the tracking information management unit 240 determines whether any one of persons in a previous input image corresponds to a specific person. To this end, the tracking information management unit 240 may determine whether there is a region corresponding to the object region of the specific person in at least one previous object region detected from the previous input image.

Specifically, the tracking information management unit 240 selects one in at least one previous object region detected from the previous input image. The tracking information management unit 240 calculates an IoU value between the selected previous object region and the object region of the specific person in the current input image. When the calculated IoU value is greater than a predetermined reference value, the tracking information management unit 240 determines that the selected previous object region corresponds to the object region of the specific person. That is, the tracking information management unit 240 determines that the person corresponding to the selected previous object region and the specific person are the same person. By way of example, the tracking information management unit 240 may use the IoU value between the previous whole body region included in the previous object region and the whole body region of the specific person in the current input image to determine that the person corresponding to the previous whole body region and the specific person are the same person.

When there is the previous object region corresponding to the object region of the specific person, the tracking information management unit 240 updates the tracking information of the person corresponding to the previous object region based on the position information and estimated attributes of the whole body region of the specific person. The coordinates, age, and gender of the whole body region included in the tracking information are updated.

According to an embodiment of the present disclosure, the tracking information management unit 240 may update the tracking information based on the confidence of the attributes. Specifically, the tracking information management unit 240 acquires the confidence of the previous attributes included in the tracking information of the person corresponding to the previous object region. The tracking information management unit 240 compares the confidence of the previous attributes with the confidence of the estimated attributes of the specific person. When the confidence of the estimated attributes is higher than the confidence of the previous attributes, the tracking information management unit 240 updates the tracking information so that the tracking information includes the position information of the whole body region of the specific person and the estimated attributes of the specific person. By way of example, when at least one of the confidence of the estimated age and the confidence of the estimated gender for the specific person is higher than at least one of the previous age confidence and the previous gender confidence, the tracking information management unit 240 may update the tracking information.

Meanwhile, if there is no person corresponding to the previous object region in the current input image, the tracking information management unit 240 stops tracking the corresponding person.

Through the above-described process, the attribute estimation device 20 may track the movement and attributes of the specific person in a video captured by the camera, thereby analyzing the characteristics of population coming in and out of a place where the camera is installed.

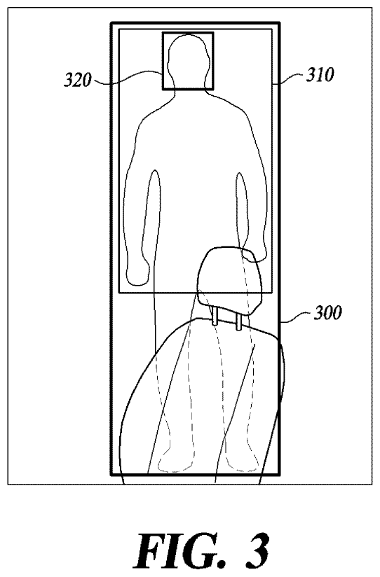

FIG. 3 is a diagram illustrating a object region according to an embodiment of the present disclosure.

Referring to FIG. 3, a whole body region 300, visible body region 310, and head region 320 of a person are shown.

According to an embodiment of the present disclosure, the attribute estimation device is a object region, and detects the whole body region 300, visible body region 310, and head region 320 from the input image.

The whole body region 300 includes the head, torso, both arms, both legs, and both feet of the person. Particularly, the whole body region 300 includes the person's lower body obscured by a chair. The whole body region 300 including the obscured lower body may be detected by a deep learning-based detection model.

The visible body region 310 includes the torso, both arms, and head of the person's whole body that are not obscured by the chair.

The head region 320 includes the person's head.

In FIG. 3, each of the whole body region 300, visible body region 310, and head region 320 is expressed as a bounding box with four sides bordering the outline of a corresponding object. However, in another example, each of the whole body region 300, visible body region 310, and head region 320 may have various shapes, and may be composed of numerous coordinates.

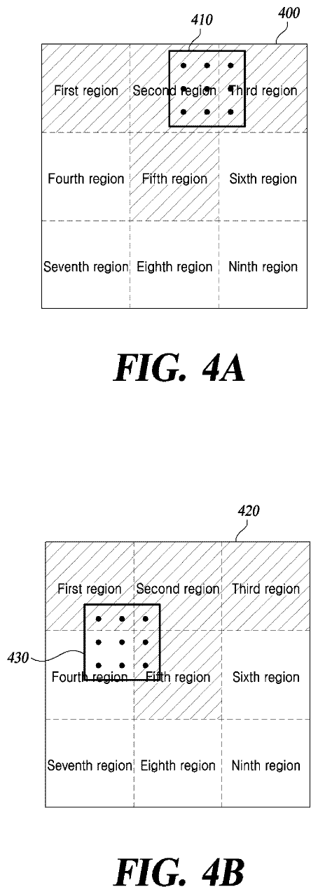

FIGS. 4A and 4B are diagrams illustrating a proper posture of a person according to an embodiment of the present disclosure.

Referring to FIGS. 4A and 4B, a first whole body region 400, a first head region 410, a second whole body region 420, and a second head region 430 are shown.

In order to set a region of interest, the attribute estimation device may divide each of the first whole body region 400 and the second whole body region 420 into a plurality of sub-regions. For example, the attribute estimation device may divide each of the first whole body region 400 and the second whole body region 420 into first to ninth regions.

The attribute estimation device sets some of the divided regions as a region of interest. Here, the region of interest represents a region where a person's head may be located. Generally, the person's head is located in the upper center, and has a predetermined range of movement. Thus, the attribute estimation device may set the first to third regions and the fifth region as the region of interest.

The attribute estimation device may determine whether the person has an appropriate posture by considering a relative position between the first head region 410 and the region of interest.

Specifically, the attribute estimation device sets 9 points inside the first head region 410. When 6 or more of the 9 set points are located within the region of interest, the attribute estimation device determines that the person's posture is appropriate.

In FIG. 4A, since all nine points in the first head region 410 are within the region of interest, the attribute estimation device determines that the person's posture is in an appropriate posture.

On the other hand, in FIG. 4B, since only five points among nine points in the second head region 430 are within the region of interest, the attribute estimation device determines that the person's posture is in an inappropriate posture.

Subsequently, the attribute estimation device estimates the attributes only for a person who is determined to have an appropriate posture. The attribute estimation device may not estimate the attributes of a person who is determined to have an inappropriate posture, thereby reducing the possibility of incorrectly determining the attributes of the person.

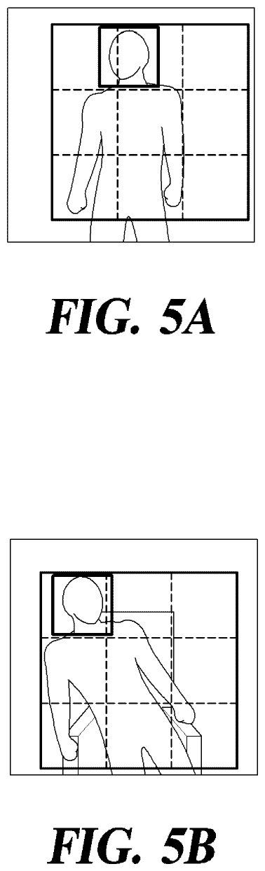

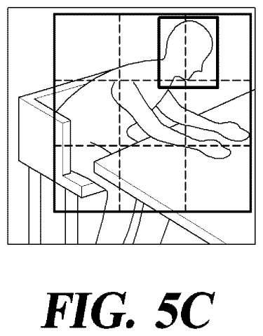

FIGS. 5A, 5B, and 5C are diagrams illustrating various postures of a person according to an embodiment of the present disclosure.

Referring to FIG. 5A, the head region of the person is located in the upper region and mid-upper region within the whole body region. The attribute estimation device determines that the person's posture is appropriate, and estimates the person's attributes.

Referring to FIG. 5B, the head region of the person is biased toward the left region and the upper-left region within the whole body region. The attribute estimation device determines that the person's posture is inappropriate, and does not estimate the person's attributes.

Referring to FIG. 5C, the person's head region is located in the middle region, upper region, and upper-right region as well as the middle right region within the whole body region. The attribute estimation device determines that the person's posture is inappropriate, and does not estimate the person's attributes.

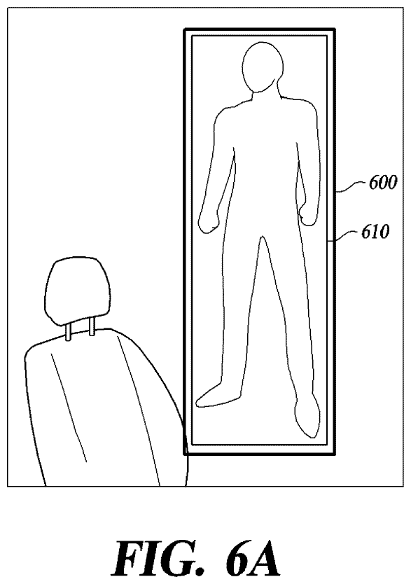

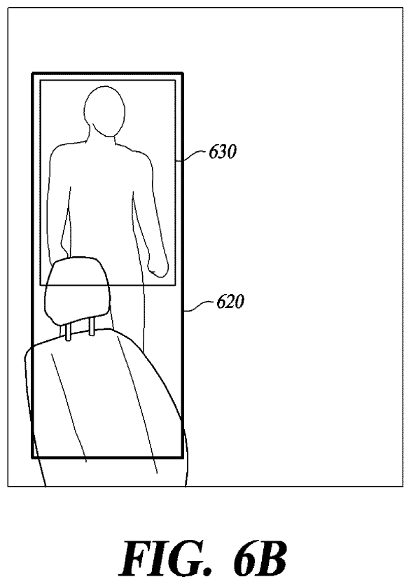

FIGS. 6A and 6B are diagrams illustrating the occlusion degree of a person according to an embodiment of the present disclosure.

Referring to FIG. 6A, a first whole body region 600 and a first visible body region 610 are shown.

The attribute estimation device determines the occlusion degree based on a ratio of an overlapping area between the first whole body region 600 and the first visible body region 610.

First, the attribute estimation device calculates IoU between the first whole body region 600 and the first visible body region 610, as the ratio of an overlapping area between the first whole body region 600 and the first visible body region 610. In FIG. 6A, since the person is not obscured by the obstacle, the first whole body region 600 and the first visible body region 610 are almost identical. IoU between the first whole body region 600 and the first visible body region 610 may be calculated as 0.9, which is close to 1. A larger IoU between the first whole body region 600 and the first visible body region 610 indicates a smaller degree of occlusion.

The attribute estimation device determines whether to estimate the attributes of a corresponding person based on the occlusion degree, namely, IoU between the first whole body region 600 and the first visible body region 610. Specifically, when IoU between the first whole body region 600 and the first visible body region 610 is greater than a preset reference value, the attribute estimation device determines that it is appropriate to estimate the attributes of the person. By way of example, the reference value may be 0.7. Since IoU between the first whole body region 600 and the first visible body region 610 is 0.9 that is greater than 0.7, the attribute estimation device determines to estimate the person's attributes.

On the other hand, referring to FIG. 6B, a second whole body region 620 and a second visible body region 630 are shown.

The attribute estimation device calculates IoU between the second whole body region 620 and the second visible body region 630. Since the person's lower body is obscured by a chair, there is a difference between the second whole body region 620 and the second visible body region 630. The IoU between the second whole body region 620 and the second visible body region 630 may be calculated as 0.6.

Since the IoU between the second whole body region 620 and the second visible body region 630 is 0.6 that is less than 0.7, the attribute estimation device determines not to estimate the person's attributes. This is because there is a high probability of incorrectly determining the person's attributes, in the case of estimating the person's attributes even though the person is largely obscured by the obstacle.

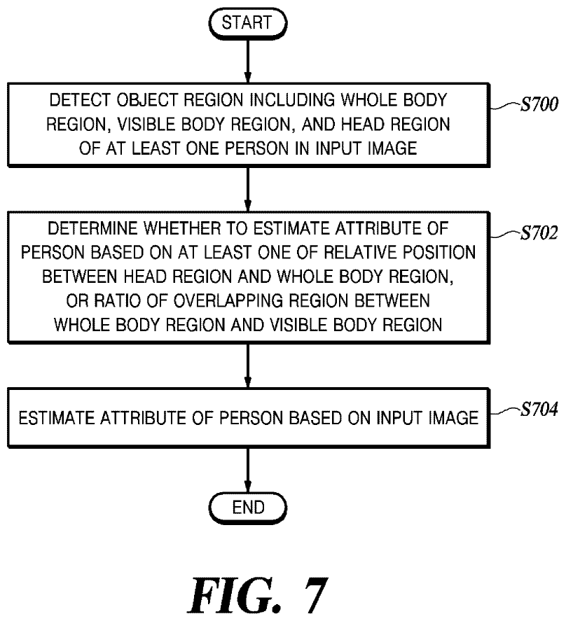

FIG. 7 is a flowchart illustrating a method for estimating attributes according to an embodiment of the present disclosure.

Referring to FIG. 7, the attribute estimation device detects an object region including a whole body region, visible body region, and head region of at least one person in an input image (S700).

According to an embodiment of the present disclosure, the attribute estimation device detects the object region using a trained detection model. At this time, the attribute estimation device may obtain confidence for each region from the detection model.

The attribute estimation device determines whether to estimate attributes of the person based on at least one of a relative position between the head region and the whole body region, or a ratio of an overlapping region between the whole body region and the visible body region (S702).

According to an embodiment of the present disclosure, the attribute estimation device sets a region of interest in the whole body region, and determines to estimate the attributes of the person when a part of the head region is located in the region of interest.

According to an embodiment of the present disclosure, the attribute estimation device determines to estimate the attributes of the person when the ratio of the overlapping region between the whole body region and the visible body region is higher than a preset ratio.

The attribute estimation device may first determine a posture according to the relative position between the whole body region and the head region, and then determine the occlusion degree. The reverse order is also possible.

Subsequently, when it is determined to estimate the attributes of the person, the attribute estimation device estimates the person's attributes based on the input image (S704).

Here, the attributes of the person include at least one of the person's gender or age.

According to an embodiment of the present disclosure, the attribute estimation device detects the person's torso region in the input image, and estimates the attributes of the person based on the torso region. At this time, the attribute estimation device may estimate the attributes of the person using the trained estimation model.

Meanwhile, the attribute estimation device may track the movement and attributes of the person within a plurality of images.

The attribute estimation device determines whether there is a previous object region corresponding to an object region in at least one previous object region detected from a previous input image.

When there is no corresponding previous object region, the attribute estimation device generates tracking information of the person based on the position information of the whole body region and the estimated attributes.

When there is a corresponding previous object region, the attribute estimation device updates the tracking information of the person corresponding to the previous object region based on the position information of the whole body region and the estimated attributes.

At this time, during the update process, the attribute estimation device may update the tracking information considering the confidence. Specifically, the attribute estimation device compares the confidence of the previous attributes included in the tracking information of the person corresponding to the previous object region and the confidence of the current estimated attributes. When the confidence of the estimated attributes is higher than the confidence of the previous attributes, the attribute estimation device replaces the previous attributes included in the person's tracking information with the estimated attributes.

Meanwhile, the attribute estimation device may estimate the attributes of the person from a person's facial region instead of a person's torso region within the input image. Hereinafter, a method of identifying a person using the person's facial region will be described.

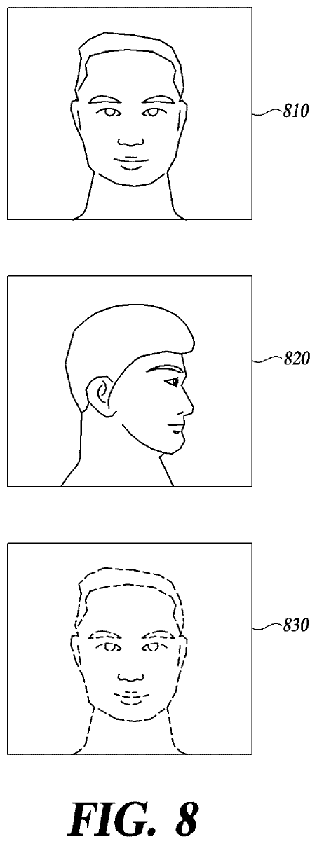

FIG. 8 is a diagram showing head images photographed in various situations.

Referring to FIG. 8, a first object 810 for a person's head looking straight toward a camera within an image, a second object 820 for a person's head looking to the side, and a third object 830 for a person's head looking straight ahead within a blurry image are shown.

A device (hereinafter referred to as “attribute estimation device”) for estimating attributes such as the age or gender of a person in the image detects a head object corresponding to the person's head and a facial object corresponding to the face in the image, and estimates the attributes of the person based on the detected objects. At this time, if the object is not facing the camera directly or the object image is blurry, it is difficult for the attribute estimation device to accurately estimate the attributes of the person corresponding to the object. This is because a clear, forward-looking image of the person's face contains a lot of information for distinguishing the person's attributes.

In FIG. 8, since the second object 820 is not facing the camera and the image quality of the third object 830 is not clear, there is a high probability that the attribute estimation device incorrectly determines the attributes of each of the second object 820 and the third object 830. This deteriorates recognition performance for the object attributes.

On the other hand, since the first object 810 faces the camera directly and has a low amount of blur, the attribute estimation device may estimate the attributes of the first object 810 more accurately than the attributes of the second object 820 and the third object 830.

As such, if the attribute estimation device distinguishes between a person who is the target of attribute estimation and a person who is not the target of attribute estimation based on the amount of blur and the face pose, providing incorrect information about the person who is not subject to attribute estimation can be prevented. That is, the entire recognition performance can be improved.

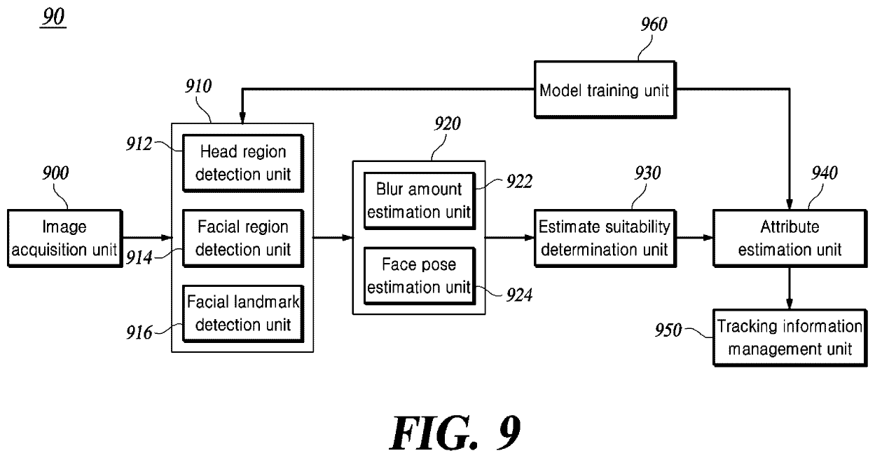

FIG. 9 is a block diagram illustrating a device for estimating attributes according to an embodiment of the present disclosure.

Referring to FIG. 9, the attribute estimation device 90 includes a detection unit 910, an estimation unit 920, an estimate suitability determination unit 930, and an attribute estimation unit 940. The attribute estimation device 90 may further include at least one of an image acquisition unit 900, a tracking information management unit 950, or a model training unit 960.

The image acquisition unit 900 acquires an input image by capturing a scene including a person using the camera. Here, the camera may be an AI camera that photographs the scene and processes the photographed image.

Although an operation for estimating the attributes of any selected specific person in an image will be described below, the operation may be equally and simultaneously applied to several persons in the image.

The detection unit 910 detects the head region of a specific person within the input image, and detects the facial region and facial landmarks of the specific person within the head region.

The detection unit 910 includes a head region detection unit 912, a facial region detection unit 914, and a facial landmark detection unit 916.

The head region detection unit 912 detects a head region of a specific person among persons within the input image. The facial region detection unit 914 detects a facial region including the face of the specific person within the head region. The facial landmark detection unit 916 detects the facial landmarks including the positions of both eyes, the position of the nose, and the left and right positions of the corners of the mouth within the head region. Each position coordinate may be detected as a 2D coordinate or a 3D coordinate.

According to an embodiment of the present disclosure, the detection unit 910 detects the head region using a first detection model based on the deep neural network, and detects the facial region and facial landmarks from the head region using a second detection model.

Specifically, when the input image including the person's head is input, the first detection model provides position coordinates regarding the person's head region. For example, when the head region has the shape of a bounding box, the first detection model provides the upper-left coordinate, lower-left coordinate, upper-right coordinate, and lower-right coordinate of the head region. Moreover, the first detection model may also provide the confidence for the head region. The confidence may be quantified as a value between 0 and 1. At this time, it is difficult to use a region with low confidence.

When the head image corresponding to the head region is input, the second detection model provides position coordinates and facial landmarks regarding the person's facial region. For example, when the head region has the shape of a bounding box, the second detection model provides the upper-left coordinate, lower-left coordinate, upper-right coordinate, and lower-right coordinate of the facial region. In addition, the facial landmarks are provided. Further, the second detection model may provide the confidence for the facial region and facial landmarks. The second detection model may be divided into a model that detects the facial region and a model that detects the facial landmarks.

To create each detection model, the model training unit 960 trains the first detection model to detect at least one head region within the input image when the first detection model receives the input image, and trains the second detection model to detect the facial region and facial landmarks within the head region when the second detection model receives the head region image.

Each detection model may be trained using supervised learning. The model training unit 960 prepares images containing the heads of persons, and labels regions containing the heads of the persons. Labeled images are input to the first detection model as a training data set of the first detection model. Neural network parameters are updated so that the first detection model detects the regions containing the heads of the persons. On the other hand, the model training unit 960 labels the facial region and facial landmarks included in each of the head region images, and inputs the labeled images as a training data set of the second detection model. The neural network parameters are updated so that the second detection model detects the regions including the faces of the persons and the facial landmarks. Alternatively or additionally, the model training unit 960 may train the detection model using other training methods, such as unsupervised learning or reinforcement learning.

Each detection model may be composed of the deep neural network, and may have various neural network structures. For example, the detection model may have various neural network structures capable of implementing an image processing technique, such as a Recurrent Neural Network (RNN), a Convolutional Neural Network (CNN), or a coupling structure of RNN and CNN.

The detection unit 910 may adjust the size of the input image to use the detection model.

The estimation unit 920 estimates the amount of blur of the facial region based on the detection information of the detection unit 910, and estimates the face pose of a specific person.

The estimation unit 920 includes a blur amount estimation unit 922 and a face pose estimation unit 924.

The blur amount estimation unit 922 reduces a face image corresponding to the facial region and then enlarges the face image, and estimates the amount of blur based on a difference between the face image before reduction and the enlarged face image.

Specifically, the blur amount estimation unit 920 down-samples the face image corresponding to the detected facial region. The blur amount estimation unit 920 restores the face image by up-sampling the down-sampled face image again.

At this time, because some information is lost or transformed during the down-sampling process and the up-sampling process, a difference occurs between the detected face image and the restored face image. The less blurred or smudged the face image is, that is, the clearer the face image is, the greater the difference between the face image and the restored face image becomes.

Using this, the blur amount estimation unit 920 estimates the blur amount based on a difference between the face image and the restored face image. When the difference between the face image and the restored face image is large, the blur amount estimation unit 920 estimates that the blur amount of the face image is low. On the other hand, when the difference between the face image and the restored face image is small, the blur amount estimation unit 920 estimates that the blur amount of the face image is high.

The blur amount estimation unit 920 may calculate Mean Square Error (MSE) between the face image and the restored face image using Equation 2, and quantify the blur amount through the MSE.

$${S}_{MSE} = \frac{1}{n} {\sum }_{i = 1}^{n} {( {x}_{i} - {\hat{x}}_{i} )}^{2} \qquad [ Equation 2 ]$$

In Equation 2, S_{MSE} indicates the blur amount, n indicates the number of pixels in the face image, i indicates a pixel index, and xi indicates the intensity of an i-th pixel in the face image. \hat{x}ᵢ indicates the intensity of an i-th pixel in the restored face image.

The face pose estimation unit 924 estimates at least one of the yaw, pitch, or roll of a specific person's face as the face pose using the facial landmarks.

Specifically, in order to estimate the face pose, the face pose estimation unit 924 uses four straight lines. Among four straight lines, a first straight line is a straight line connecting the position of the left eye and the left corner of the mouth. A second straight line is a straight line connecting the position of the right eye and the right corner of the mouth. A third straight line is a straight line connecting the positions of both eyes. A fourth straight line is a straight line connecting the left and right positions of the corners of the mouth.

The face pose estimation unit 924 calculates a first distance between the first straight line and the nose position, and calculates a second distance between the second straight line and the nose position. The face pose estimation unit 924 estimates the yaw of the face based on a difference between the first distance and the second distance.

The face pose estimation unit 924 calculates a third distance from the nose position to the third straight line, and calculates a fourth distance from the nose position to the fourth straight line. The face pose estimation unit 924 estimates the pitch of the face based on a difference between the third distance and the fourth distance.

The face pose estimation unit 924 estimates the roll of the face based on the slope of the third straight line. By way of example, the face pose estimation unit 924 may estimate the angle at which the third straight line is rotated counterclockwise from a horizontal line passing through the position of the right eye, as the roll of the face.

Meanwhile, the face pose estimation unit 924 may use a vector to estimate the face pose. Vectors pointing from the nose position to the first, second, third, and fourth straight lines, respectively, may be referred to as a first vector, a second vector, a third vector, and a fourth vector. The face pose estimation unit 924 may estimate the yaw of the face based on the sum of the first vector and the second vector, and may estimate the pitch of the face based on the sum of the third vector and the fourth vector. At this time, the face pose estimation unit 924 may normalize the yaw and pitch of the face.

The estimate suitability determination unit 930 determines whether at least one of the blur amount of the facial region or the face pose of the specific person is appropriate for estimating the attributes of the specific person.

According to an embodiment of the present disclosure, when a difference between the face image and the restored face image is greater than a preset reference value, the estimate suitability determination unit 930 determines that the blur amount of the facial region is appropriate for estimating the attributes of the specific person.

According to an embodiment of the present disclosure, when the yaw, pitch, and roll of the face are smaller than a preset yaw reference value, pitch reference value, and roll reference value, respectively, the estimate suitability determination unit 930 determines that the face pose is appropriate for estimating the attributes of the specific person.

According to an embodiment of the present disclosure, when at least one of the yaw, pitch, or roll of the face is smaller than at least one of a preset yaw reference value, pitch reference value, or roll reference value, the estimate suitability determination unit 930 may determine that the face pose is appropriate for estimating the attributes of the specific person. By way of example, when the roll of the face is smaller than 30 degrees, the estimate suitability determination unit 930 determines that the roll of the face is appropriate for estimating the attributes of the specific person.

Meanwhile, according to an embodiment of the present disclosure, the estimate suitability determination unit 930 may determine whether the facial region detected based on the ratio of the facial region to the head region is appropriate for estimating the attributes of the specific person, prior to the blur amount of the facial region and the face pose. A smaller area of the facial region compared to the area of the head region means that the face of the specific person is not facing straight ahead. The estimate suitability determination unit 930 may calculate IoU, which represents the ratio of the overlapping area between the head region and the facial region.

Here, IoU is a value obtained by dividing the overlapping area of the two regions by a total area of the two regions summed. IoU between regions A and B may be expressed as Equation 3.

$$IoU ( A , B ) = \frac{( A ⋂ B )}{( A ⋃ B )} \qquad [ Equation 3 ]$$

When the ratio of the facial region to the head region is higher than a preset ratio, the estimate suitability determination unit 930 determines that the facial region is appropriate for estimating the attributes of the specific person. On the other hand, when the ratio of the facial region to the head region is lower than a preset ratio, the estimate suitability determination unit determines that the facial region is inappropriate for estimating the attributes of the specific person, and the corresponding facial region is ignored.

According to an embodiment of the present disclosure, when it is determined that the face pose is appropriate for estimating the attributes of the specific person, the estimate suitability determination unit 930 may determine the quality of the face pose based on the first distance, second distance, third distance, and fourth distance. Specifically, when a distance between the first distance and the second distance is small, the estimate suitability determination unit 930 determines that the quality of the face pose is high. Further, when a difference between the third distance and the fourth distance is small, the estimate suitability determination unit 930 determines that the quality of the face pose is high.

The quality of the face pose may be expressed as Equation 4.

$$Q = 1 - {dist}_{v} \times {dist}_{h} \qquad [ Equation 4 ]$$

In Equation 4, Q refers to the quality of the face pose, distᵥ refers to a difference between the first distance and the second distance, and distₕ refers to a difference between the third distance and the fourth distance.

The attribute estimation unit 940 estimates the attributes of the specific person based on the facial region.

Here, the attributes include at least one of gender or age. That is, the attribute estimation unit 940 may estimate at least one of the gender or age of the specific person. In addition, the attributes of the specific person may include various pieces of physical information such as race, ethnicity, or emotion.

According to an embodiment of the present disclosure, the attribute estimation unit 940 may estimate the attributes of the specific person using the deep neural network-based estimation model. When the image of the person's face is input, the estimation model provides at least one of gender or age. The estimation model may further provide the confidence of at least one of gender or age. The confidence may be quantified as a value between 0 and 1.

In order to create the estimation model, the model training unit 960 trains the estimation model to output at least one of gender or age when the estimation model receives the face image.

The estimation model may be learned by various learning methods such as supervised learning, unsupervised learning, or reinforcement learning. The estimation model may have various neural network structures such as RNN or CNN.

The estimation model estimates the attributes of a person more accurately when the person is facing straight ahead and the blur amount of the face image is small.

Using the above-described configurations, the attribute estimation device 90 may improve the overall estimation accuracy of the attributes of the persons in the image by filtering the person whose attributes are to be estimated based on the blur amount of the facial region or the face pose in the image.

Meanwhile, according to an embodiment of the present disclosure, the attribute estimation device 90 may include the tracking information management unit 950 to track the person's movement in a plurality of images and manage the tracking information.

After estimating the attributes of the specific person in the current input image, the tracking information management unit 950 checks whether the input image acquired by the image acquisition unit 900 is a first image.

If the input image is the first image, the tracking information management unit 950 generates tracking information based on the position information and estimated attributes of the head region of the specific person. The generated tracking information includes at least one of the identification information of the specific person, the coordinates of the head region, the confidence of the coordinates, the estimated age, the confidence of the estimated age, the estimated gender, or the confidence of the estimated gender. The age confidence and the gender confidence may be adjusted based on the quality of the face pose, which will be described later.

If the input image is not the first image, the tracking information management unit 950 determines whether any one of persons in a previous input image corresponds to a specific person. To this end, the tracking information management unit 950 may determine whether there is a region corresponding to the head region of the specific person in at least one previous head region detected from the previous input image.

Specifically, the tracking information management unit 950 selects one in at least one previous head region detected from the previous input image. The tracking information management unit 950 calculates an IoU value between the selected previous head region and the head region of the specific person in the current input image. When the calculated IoU value is greater than a predetermined reference value, the tracking information management unit 950 determines that the selected previous head region corresponds to the head region of the specific person. That is, the tracking information management unit 950 determines that the person corresponding to the selected previous head region and the specific person are the same person.

When there is the previous object region corresponding to the head region of the specific person, the tracking information management unit 950 updates the tracking information of the person corresponding to the previous head region based on the position information and estimated attributes of the head region of the specific person. The coordinates, age, and gender of the head region included in the tracking information are updated.

According to an embodiment of the present disclosure, the tracking information management unit 950 may update the tracking information based on the confidence of the attributes. Specifically, the tracking information management unit 950 acquires the confidence of the previous attributes included in the tracking information of the person corresponding to the previous head region. The tracking information management unit 950 compares the confidence of the previous attributes with the confidence of the estimated attributes of the specific person. When the confidence of the estimated attributes is higher than the confidence of the previous attributes, the tracking information management unit 950 updates the position information of the previous head region and the previous attributes with the position information of the head region of the specific person and the estimated attributes of the specific person. By way of example, when at least one of the confidence of the estimated age and the confidence of the estimated gender for the specific person is higher than at least one of the previous age confidence and the previous gender confidence, the tracking information management unit 950 may update the tracking information.

According to another embodiment of the present disclosure, the tracking information management unit 950 may adjust the confidence of the attributes based on the quality of the face pose, and update the tracking information based on the adjusted confidence. Specifically, the tracking information management unit 950 obtains the confidence of the previous attributes included in the tracking information of the person corresponding to the previous head region. Here, the confidence of the previous attributes is adjusted based on the quality of the previous face pose. The tracking information management unit 950 adjusts the estimated attribute confidence by multiplying the estimated attribute confidence by the quality of the face pose. The tracking information management unit 950 compares the previous attribute confidence with the adjusted confidence of the estimated attributes of the specific person. When the adjusted confidence of the estimated attributes is higher than the confidence of the previous attributes, the tracking information management unit 950 updates the position information of the previous head region and the previous attributes with the position information of the head region of the specific person and the estimated attributes of the specific person. By way of example, when at least one of the adjusted confidence of the estimated age and the adjusted confidence of the estimated gender for the specific person is higher than at least one of the confidence of the previous age and the confidence of the previous gender, the tracking information management unit 950 may update the tracking information.

Meanwhile, if there is no person corresponding to the previous head region in the current input image, the tracking information management unit 950 stops tracking the corresponding person.

Through the above-described process, the attribute estimation device 90 may track the movement and attributes of the specific person in a video captured by the camera, thereby analyzing the characteristics of population coming in and out of a place where the camera is installed.

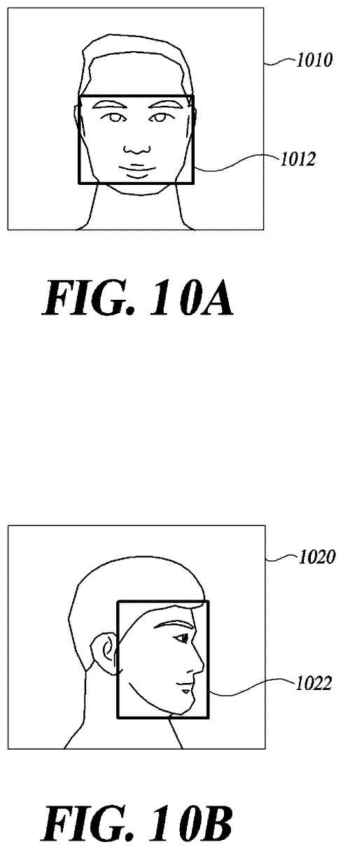

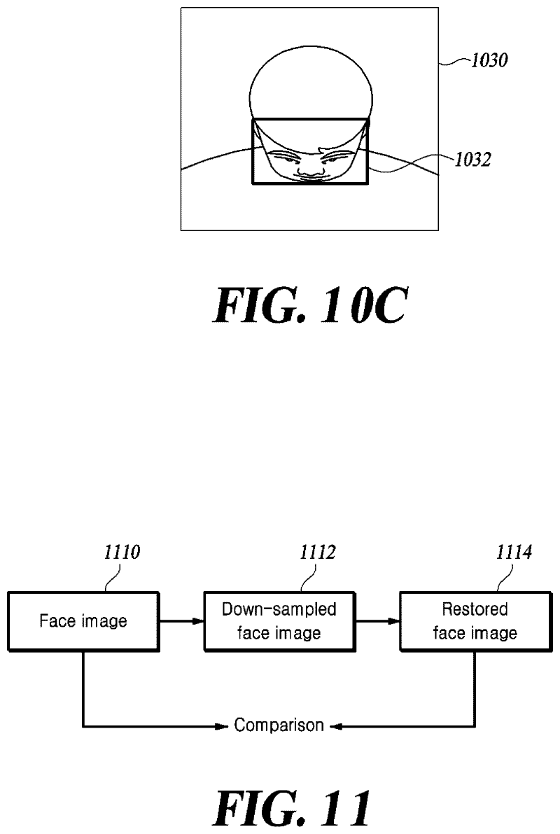

FIGS. 10A, 10B, and 10C are diagrams illustrating the determination of the estimation suitability of a facial region according to an embodiment of the present disclosure.

The attribute estimation device according to an embodiment of the present disclosure uses IoU, which represents the ratio of the facial region to the head region, to determine whether the facial region is appropriate for estimating the attributes of the person. When the person's head is looking straight ahead, IoU between the head region and the facial region is high. On the other hand, when the head is away from the front, IoU is low.

Referring to FIG. 10A, a first head region 1010 and a first facial region 1012 are shown.

The attribute estimation device calculates first IoU, which represents the ratio of the overlapping area between the first head region 1010 and the first facial region 1012. Since the person's head is looking to the front, the first IoU is calculated higher than IoU value according to the side face. When the first IoU is greater than the preset IoU value, the attribute estimation device determines that the first facial region 1012 is of an appropriate size for estimating the person's attributes, and uses it to estimate the attributes.

Referring to FIGS. 10B and 10C, a second head region 1020, a second facial region 1022, a third head region 1030, and a third facial region 1032 are shown.

Unlike FIG. 10A, in FIG. 10B, the person's head is looking to the side. In FIG. 10C, the person's head is looking downward. Second IoU between the second head region 1020 and the second facial region 1022, and third IoU between the third head region 1030 and the third facial region 1032 are smaller than the first IoU. When the second IoU and the third IoU are smaller than the preset IoU value, the attribute estimation device determines that the second facial region 1022 or the third facial region 1032 are inappropriate for estimating the person's attributes.

FIG. 11 is a diagram illustrating the determination of the blur amount of a facial region according to an embodiment of the present disclosure.

Referring to FIG. 11, in order to determine the blur amount of the facial region, the attribute estimation device down-samples a face image 1110 corresponding to the facial region. In this connection, the down-sampling means reducing the face image 1110. By way of example, the attribute estimation device may down-sample the face image 1110 by selecting pixels included in the face image 1110.

The attribute estimation device up-samples the down-sampled face image 1112. Here, the up-sampling is to enlarge the down-sampled face image 1112. The attribute estimation device may perform the up-sampling by adding predetermined pixels from pixels included in the down-sampled face image 1112. By way of example, the attribute estimation device may use a deep learning-based model that converts a low-definition image into a high-definition image. The attribute estimation device obtains a restored face image 1114 by up-sampling the down-sampled face image 1112.

Meanwhile, in the down-sampling process of the face image 1110, pixel information included in the face image 1110 is lost. Further, in the process of up-sampling the down-sampled face image 1112, pixels different from the pixels included in the face image 1110 are added. Thus, a difference occurs between the face image 1110 and the restored face image 1114. Particularly, the lower the blur amount of the face image 1110 is, the greater a difference between the face image 1110 and the restored face image 1114 becomes.

The attribute estimation device calculates Mean Square Error (MSE) between the face image 1110 and the restored face image 1114.

When the calculated MSE is greater than a preset error value, the attribute estimation device determines that the blur amount of the face image 1110 is low. Moreover, the attribute estimation device determines that the blur amount of the face image 1110 is appropriate for estimating the person's attributes.

On the other hand, when the calculated MSE is smaller than the preset error value, the attribute estimation device determines that the blur amount of the face image 1110 is high. The attribute estimation device determines that the blur amount of the face image 1110 is inappropriate for estimating the person's attributes.

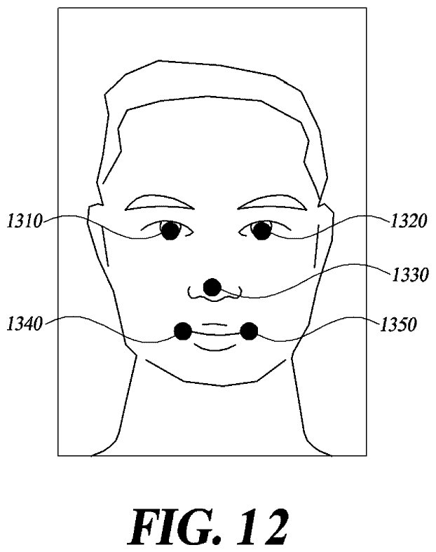

FIG. 12 is a diagram showing facial landmarks according to an embodiment of the present disclosure.

Referring to FIG. 12, as facial landmarks, a right eye position 1310, a left eye position 1320, a nose position 1330, a right mouth corner position 1340, and a left mouth corner position 1350 are shown.

The positions of the facial landmarks shown in FIG. 12 are only one embodiment, and the positions of the facial landmarks may be changed in other embodiments.

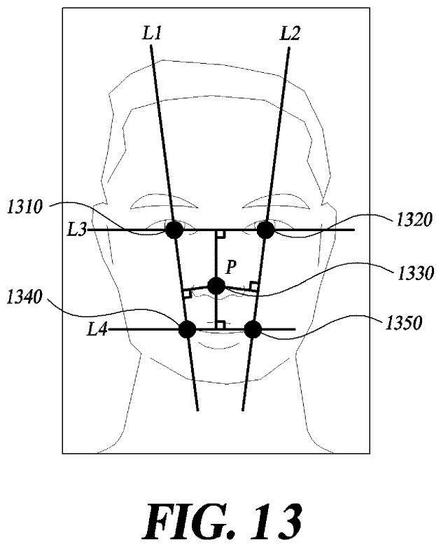

FIG. 13 is a diagram illustrating the estimation of a face pose according to an embodiment of the present disclosure.

Referring to FIG. 13, the right eye position 1310, a left eye position 1320, a nose position 1330, the right mouth corner position 1340, the left mouth corner position 1350, a first straight line L1, a second straight line L2, a third straight line L3, and a fourth straight line L4 are shown.

The yaw, pitch, and roll of the face vary depending on the direction of the person's face. That is, the face pose may be determined based on the yaw, pitch, and roll of the face.

Here, the yaw of the face refers to a degree to which the face is rotated in a horizontal direction. The yaw of the face is related to a direction in which the person shakes his or her head.

The pitch of the face refers to a degree to which the face is rotated in a vertical direction. The pitch of the face is related to a direction in which the person nods.

The roll of the face refers to the tilt of the face. This is related to a direction in which the person tilts his or her head.

When the yaw, pitch, and roll of the face are smaller than a preset yaw reference value, pitch reference value, and roll reference value, respectively, the attribute estimation device may determine that the face pose is appropriate for estimating the attributes of the person. On the other hand, when the yaw, pitch, and roll of the face are greater than the preset yaw reference values, respectively, the attribute estimation device may determine that the face pose is inappropriate for estimating the attributes of the person.

Hereinafter, a method of estimating the yaw, pitch, and roll of the face will be described.

The attribute estimation device uses a distance from the nose position 1330 to each straight line and the slope of the third straight line L3 to estimate the yaw, pitch, and roll of the face.

First, the attribute estimation device estimates a first distance difference between the distance from the nose position 1330 to the first straight line L1 and the distance from the nose position 1330 to the second straight line L2 as the yaw value of the face. When the direction of the face is toward the front, the first distance difference is smallest. When the yaw size of the face increases, the first distance difference increases. The first distance difference when the direction of the face is toward the side is larger than that when it is toward the front.

The attribute estimation device estimates a second distance difference between the distance from the nose position 1330 to the third straight line L3 and the distance from the nose position 1330 to the fourth straight line L4 as the pitch value of the face. When the direction of the face is toward the front, the second distance difference is smallest. When the pitch size of the face increases, the second distance difference increases. The second distance difference when the direction of the face is downward is larger than that when it is toward the front.

The attribute estimation device estimates the slope of the third straight line L3 as the roll value of the face. The slope of the third straight line L3 is a degree to which it I rotated counterclockwise from the horizontal line. When the face is not tilted to the side, the slope of the third straight line L3 is 0 degrees. When the roll size of the face increases, the slope of the third straight line L3 increases.

As such, the attribute estimation device may estimate the face pose based on the first distance difference, the second distance difference, and the slope of the third straight line L3 corresponding to the yaw, pitch, and roll of the face.

Meanwhile, the attribute estimation device may calculate the quality of the face pose based on the first distance difference and the second distance difference. When the first distance difference and the second distance difference are small, the attribute estimation device determines that the quality of the face pose is high quality. In contrast, when the first distance difference and the second distance difference are large, the attribute estimation device determines that the quality of the face pose is low quality. The quality of the face pose is used to update the tracking information along with the confidence of the estimated attributes.

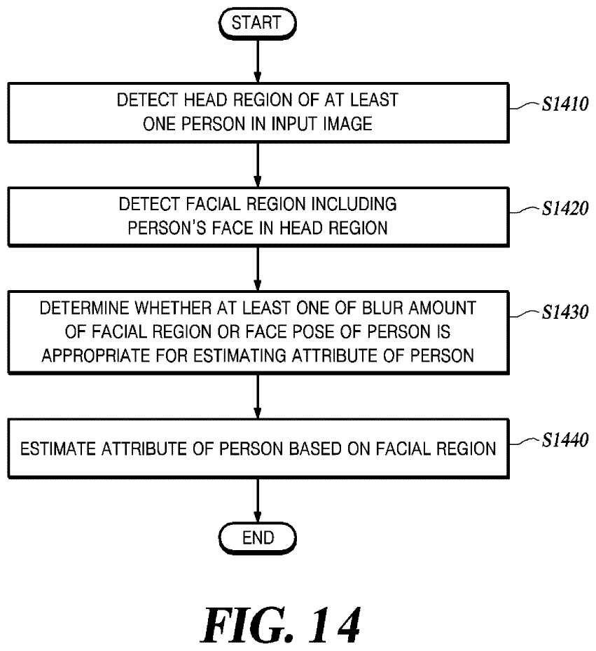

FIG. 14 is a flowchart illustrating a method for estimating attributes according to an embodiment of the present disclosure.

Referring to FIG. 14, the attribute estimation device detects a head region of at least one person in an input image (S1410).

The attribute estimation device detects a facial region including the person's face in the head region (S1420).

According to an embodiment of the present disclosure, when the ratio of the facial region to the head region is lower than a preset ratio, the attribute estimation device ignores the corresponding facial region.

According to an embodiment of the present disclosure, the attribute estimation device further detects facial landmarks including positions of both eyes, the nose position, and the left and right positions of the mouth corners in the head region.

The attribute estimation device estimates the blur amount of the facial region using the face image corresponding to the facial region. Specifically, the attribute estimation device down-samples the face image corresponding to the facial region. The attribute estimation device restores the up-sampled face image by up-sampling the down-sampled face image. The attribute estimation device calculates the blur amount of the facial region based on a difference between the face image and the restored face image. The larger the difference between the face image and the restored face image is, the smaller the blur amount of the facial region is.

The attribute estimation device estimates the face pose of the person using the facial landmarks. Specifically, the attribute estimation device estimates the yaw, pitch, and roll of the face forming the face pose using the facial landmarks. The attribute estimation device estimates the yaw of the face based on a difference between a first distance from a first straight line connecting a left eye position and a left mouth corner position to a nose position, and a second distance from a second straight line connecting a right eye position and a right mouth corner position to the nose position. The attribute estimation device estimates the pitch of the face based on a difference between a third distance from a third straight line connecting the positions of both eyes to the nose position, and a fourth distance from a fourth straight line connecting the left and right mouth corner positions to the nose position. The attribute estimation device estimates the roll of the face based on the slope of the third straight line.

The attribute estimation device determines whether at least one of the blur amount of the facial region or the face pose of the person is appropriate for estimating the attributes of the person (S1430).

When a difference between the face image and the restored face image is greater than a preset reference value, the attribute estimation device determines that the blur amount of the facial region is appropriate for estimating the attributes of the person.

When the yaw, pitch, and roll of the face are smaller than a preset yaw reference value, pitch reference value, and roll reference value, respectively, the attribute estimation device determines that the face pose is appropriate for estimating the attributes of the person.

When it is determined that at least one of the blur amount of the facial region or the face pose of the person is appropriate for estimating the attributes of the person, the attribute estimation device estimates the attributes of the person based on the facial region (S1440).

Here, the attributes of the person include at least one of the gender or age of the person.

Meanwhile, the attribute estimation device according to an embodiment of the present disclosure may track the movement and attributes of the person within a plurality of images.

The attribute estimation device determines whether there is a previous head region corresponding to a current head region in at least one previous head region detected from a previous input image.

When there is no corresponding previous head region, the attribute estimation device generates tracking information of the person based on the position information of the whole body region and the estimated attributes.

When there is a corresponding previous head region, the attribute estimation device updates the tracking information of the person corresponding to the previous head region based on the position information of the head region and the estimated attributes.

At this time, during the update process, the attribute estimation device may update the tracking information considering the confidence and the quality of the face pose. Specifically, the attribute estimation device calculates the quality of the face pose based on the difference between the first distance and the second distance, and the difference between the third distance and the fourth distance. The attribute estimation device adjusts the confidence of the estimated attributes based on the quality of the face pose.

The device compares the adjusted confidence of the previous attributes included in the tracking information of the person corresponding to the previous head region and the adjusted confidence of the estimated attributes. When the adjusted confidence of the estimated attributes is higher than the adjusted confidence of the previous attributes, the attribute estimation device replaces the previous attributes included in the tracking information of the person with the estimated attributes.

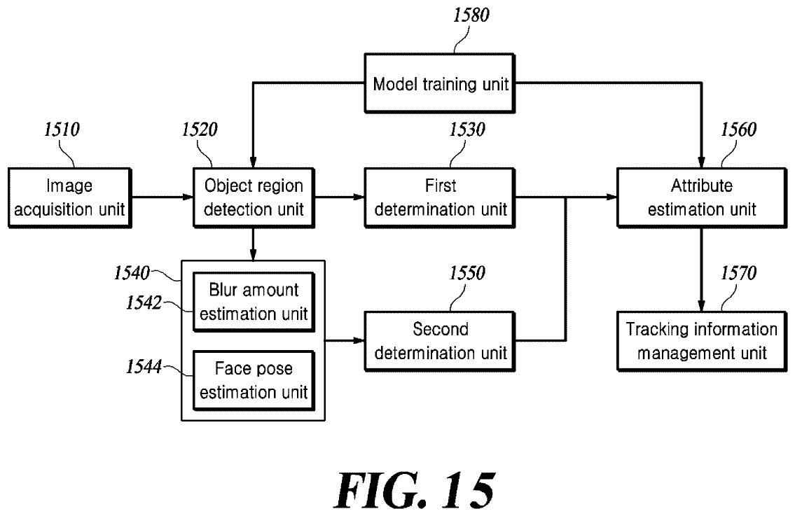

FIG. 15 is a block diagram illustrating a device for estimating attributes according to an embodiment of the present disclosure.

Referring to FIG. 15, the attribute estimation device includes an object region detection unit 1520, a first determination unit 1530, an estimation unit 1540, a second determination unit 1550, and an attribute estimation unit 1560. The attribute estimation device may further include at least one of an image acquisition unit 1510, a tracking information management unit 1570, or a model training unit 1580.

The image acquisition unit 1510 includes the functions of the image acquisition unit 200 of FIG. 2 and the functions of the image acquisition unit 900 of FIG. 9. The object region detection unit 1520 includes both the functions of the object region detection unit 210 of FIG. 2 and the functions of the detection unit 910 of FIG. 9. The first determination unit 1530 includes the functions of the estimation determination unit 220 of FIG. 2. The estimation unit 1540 includes the functions of the estimation unit 920 of FIG. 9. The second determination unit 1550 includes both the functions of the estimation determination unit 220 of FIG. 2 and the functions of the estimate suitability determination unit 930 of FIG. 9. The attribute estimation unit 1560 includes both the functions of the attribute estimation unit 230 of FIG. 2 and the functions of the attribute estimation unit 940 of FIG. 9. The tracking information management unit 1570 includes the functions of the tracking information management unit 240 of FIG. 2 and the functions of the tracking information management unit 950 of FIG. 9. The model training unit 1580 includes the functions of the model training unit 250 of FIG. 2 and the functions of the model training unit 960 of FIG. 9.

Specifically, the image acquisition unit 1510 acquires an input image by capturing a scene including a person using the camera.

The object region detection unit 1520 detects a region including part or all of the specific person among persons in the input image. Specifically, the object region detection unit 1520 detects an object region including a whole body region, a visible body region, and a head region of the specific person in the input image. Further, the object region detection unit 1520 detects the facial region and facial landmarks of the specific person in the head region. The object region detection unit 1520 may detect the facial landmarks including the positions of both eyes, the nose position, and the left and right positions of the mouth corners in the head region.

The object region detection unit 1520 may use detection models. To create the detection model, the model training unit 1580 trains the first detection model to detect the object region within the input image when the detection model receives the input image. The model training unit 1580 trains the second detection model to detect the landmarks within the input image.

The first determination unit 1530 determines whether to estimate the attributes of the specific person based on at least one of the posture of the specific person or the degree of occlusion.

To determine the posture of the specific person in the input image, the first determination unit 1530 uses the relative position of the head region with respect to the whole body region of the specific person. The first determination unit 1530 sets a region of interest within the whole body region. When part of the head region is located within the region of interest, the first determination unit 1530 may determine to estimate attributes of the person.

In order to determine the occlusion degree of the specific person, the first determination unit 1530 uses the ratio of a region where the whole body region overlaps the visible body region. When the ratio of the region where the whole body region overlaps the visible body region is higher than a preset ratio, the first determination unit 1530 may determine to estimate the attributes of the person.

As such, the first determination unit 1530 determines to estimate the attributes of the person based on at least one of the relative position of the head region with respect to the whole body region, or the ratio of the region where the whole body region overlaps the visible body region.

The estimation unit 1540 estimates the amount of blur of the facial region and estimates the face pose of the specific person, based on the detection information of the object region detection unit 1520. Specifically, the blur amount estimation unit 1542 down-samples the face image corresponding to the facial region, restores the up-sampled face image by up-sampling the down-sampled face image, and estimates the blur amount of the facial region based on a difference between the face image and the restored face image. The face pose estimation unit 1544 estimates at least one of the yaw, pitch, and roll of the face of the specific person, as the face pose of the person using the facial landmarks. The face pose is determined based on the yaw, pitch, and roll of the face. The yaw, pitch, and roll of the face are determined based on the facial landmarks.

The second determination unit 1550 determines whether at least one of the blur amount of the facial region or the face pose of the specific person is appropriate for estimating the attributes of the specific person.

When a difference between the face image and the restored face image is greater than a preset reference value, the second determination unit 1550 determines that the blur amount of the facial region is appropriate for estimating the attributes of the person. When the yaw, pitch, and roll of the face are smaller than a preset yaw reference value, pitch reference value, and roll reference value, respectively, the second determination unit 1550 determines that the face pose is appropriate for estimating the attributes of the person.

Meanwhile, the second determination unit 1550 calculates the ratio of the facial region to the head region. When the ratio of the facial region to the head region is lower than a preset ratio, the second determination unit 1550 ignores the facial region.

When it is determined to estimate the attributes of the person based on at least one of the determined result of the first determination unit 1530 and the determined result of the second determination unit 1550, the attribute estimation unit 1560 estimates the attributes of the person based on the input image.

By way of example, when it is determined by the first determination unit 1530 to estimate the attributes of the person, the attribute estimation unit 1560 estimates the attributes of the person based on the input image. The attribute estimation unit 1560 may detect a torso region of the person within the input image, and estimate the attributes of the person based on the torso region.

In another example, when it is determined that the attributes of the person are estimated, and at least one of the blur amount of the facial region or the face pose of the person is determined to be appropriate for estimating the attributes of the person, the attribute estimation unit 1560 estimates the attributes of the person based on the facial region.

The tracking information management unit 1570 tracks the movement of the person within a plurality of images, and manages tracking information.

In an embodiment, the tracking information management unit 1570 determines whether there is a previous object region corresponding to an object region in at least one previous object region detected from a previous input image. When there is no previous object region, the tracking information management unit 1570 generates tracking information of the person based on the position information of the whole body region and the estimated attributes. When there is a previous object region, the tracking information management unit 1570 updates the tracking information of the person corresponding to the previous object region based on the position information of the whole body region and the estimated attributes. The tracking information management unit 1570 may acquire the confidence of the estimated attributes, and update the previous attributes included in the tracking information of a corresponding person using the estimated attributes, based on comparison between the confidence of the previous attributes included in the tracking information of the corresponding person and the confidence of the estimated attributes.

In another embodiment, the tracking information management unit 1570 determines whether there is a previous head region corresponding to a head region in at least one previous head region detected from a previous input image. When there is no previous head region, the tracking information management unit 1570 generates tracking information of the person based on the position information of the head region and the estimated attributes. When there is a previous head region, the tracking information management unit 1570 updates the tracking information of the person corresponding to the previous head region based on the position information of the head region and the estimated attributes. The tracking information management unit 1570 acquires the confidence of the estimated attributes, and calculates a difference between a first distance between a first straight line connecting a left eye position and a left mouth corner position and a nose position, and a second distance between a second straight line connecting a right eye position and a right mouth corner position and the nose position. The tracking information management unit 1570 calculates a difference between a third distance between a third straight line connecting positions of both eyes and the nose position, and a fourth distance between a fourth straight line connecting left and right positions of the mouth corners and the nose position. The tracking information management unit 1570 may adjust the confidence of the estimated attributes based on the quality of the face pose. The tracking information management unit 1570 may update the previous attributes included in the tracking information of a corresponding person using the estimated attributes, based on comparison between the adjusted confidence of the previous attributes included in the tracking information of the corresponding person and the adjusted confidence of the estimated attributes.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

In the flowchart, each process is described as being sequentially executed, but this is merely an illustrative explanation of the technical idea of some embodiments of the present disclosure. Since those skilled in the art to which an embodiment of the present disclosure pertains may change and execute the process described in the flowchart within the range not departing from the essential characteristics of the embodiment of the present disclosure, and one or more of each process may be applied in parallel with various modifications and variations, the flowchart is not limited to a time-series sequence.

Although exemplary embodiments of the present disclosure have been described for illustrative purposes, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

### CROSS-REFERENCE TO RELATED APPLICATION

This application claims priority from Korean Patent Application No. 10-2022-0032834 filed on Mar. 16, 2022, and Korean Patent Application No. 10-2022-0033593 filed on Mar. 17, 2022, the disclosures of which are incorporated by reference herein in their entirety.

1. A method for estimating attributes of a person in an image, the method comprising:
detecting an object region including a whole body region, a visible body region, and a head region of at least one person in an input image;
determining whether to estimate attributes of the person based on at least one of a relative position of the head region with respect to the whole body region, or a ratio of an overlapping region between the whole body region and the visible body region; and
estimating the attributes of the person based on the input image, when it is determined to estimate the attributes of the person.

2. The method of claim 1, wherein the determining whether to estimate the attributes of the person comprises:
setting a region of interest in the whole body region; and
determining to estimate the attributes of the person when a part of the head region is located in the region of interest.

3. The method of claim 1, wherein the determining whether to estimate the attributes of the person comprises determining to estimate the attributes of the person, when the ratio of the overlapping region is higher than a preset ratio.

4. The method of claim 1, wherein the estimating the attributes of the person comprises:
detecting a torso region of the person in the input image; and
estimating the attributes of the person based on the torso region.

5. The method of claim 1, further comprising:
determining whether there is a previous object region corresponding to the object region in at least one previous object region detected from a previous input image.
generating tracking information of the person based on position information of the whole body region and the estimated attributes, when there is no previous object region; and
updating tracking information of the person corresponding to the previous object region based on the position information of the whole body region and the estimated attributes, when there is the previous object region.

6. The method of claim 5, further comprising:
acquiring confidence of the estimated attributes,
wherein the updating the tracking information of the corresponding person comprises updating previous attributes included in the tracking information of a corresponding person using the estimated attributes, based on comparison between the confidence of the previous attributes included in the tracking information of the corresponding person and the confidence of the estimated attributes.

7. The method of claim 1, further comprising:
detecting a facial region including a face of the person in the head region; and
determining whether at least one of a blur amount of the facial region or a face pose of the person is appropriate for estimating the attributes of the person,
wherein the estimating comprises estimating the attributes of the person based on the facial region, when it is determined to estimate the attributes of the person and it is determined that at least one of the blur amount of the facial region or the face pose of the person is appropriate for estimating the attributes of the person.

8. The method of claim 7, further comprising:
down-sampling a face image corresponding to the facial region;
restoring an up-sampled face image by up-sampling the down-sampled face image; and
estimating the blur amount of the facial region based on a difference between the face image and the restored face image.

9. The method of claim 8, wherein the determining comprises:
determining that the blur amount of the facial region is appropriate for estimating the attributes of the person, when a difference between the face image and the restored face image is greater than a preset reference value.

10. The method of claim 7,
wherein the face pose is determined based on the yaw, pitch, and roll of the face, and
wherein the determining comprises:
determining that the face pose is appropriate for estimating the attributes of the person, when the yaw, pitch, and roll of the face are smaller than a preset yaw reference value, pitch reference value, and roll reference value, respectively.

11. The method of claim 10, further comprising:
detecting facial landmarks including positions of both eyes, a position of the nose, and left and right positions of the corners of the mouth within the head region, and
wherein the yaw, pitch, and roll of the face are determined based on the facial landmarks.

12. The method of claim 7, further comprising:
calculating a ratio of the facial region to the head region; and
ignoring the facial region, when the ratio of the facial region to the head region is lower than a preset ratio.

13. The method of claim 11, further comprising:
determining whether there is a previous head region corresponding to the head region in at least one previous head region detected from the previous input image;
generating tracking information of the person based on position information of the head region and the estimated attributes, when there is no previous head region; and
updating tracking information of the person corresponding to the previous head region based on the position information of the head region and the estimated attributes, when there is the previous head region.

14. A device for estimating attributes of a person in an image, the device comprising:
an object region detection unit detecting an object region including a whole body region, a visible body region, and a head region of at least one person in an input image;
an estimation determination unit determining whether to estimate the attributes of the person based on at least one of a relative position of the head region with respect to the whole body region, or a ratio of an overlapping region between the whole body region and the visible body region; and
an attribute estimation unit estimating the attributes of the person based on the input image, when it is determined to estimate the attributes of the person.
